(19) United States
(12) Patent Application Publication
(10) Pub. No.: US 2013/0205211 A1
(43) Pub. Date: Aug. 8, 2013

(54) SYSTEM AND METHOD FOR ENTERPRISE INFORMATION DISSEMINATION

(71) Applicants: David James Warren, San Diego, CA (US); Abdolreza Zadeh, Los Angeles, CA (US); Scott Holmes, Agoura Hills, CA (US); Lorenzo F. Gonzalez, Westlake Village, CA (US)

(72) Inventors: David James Warren, San Diego, CA (US); Abdolreza Zadeh, Los Angeles, CA (US); Scott Holmes, Agoura Hills, CA (US); Lorenzo F. Gonzalez, Westlake Village, CA (US)

(73) Assignee: Gray Suit Marketing, Inc.

(21) Appl. No.: 13/366,825

(22) Filed: Feb. 6, 2012

(51) Int. Cl. G06F 3/01; G06F 17/30

(52) U.S. Cl. 715/719; 707/769; 707/E17.014

(57) ABSTRACT

An enterprise information management system is provided which establishes, at an Internet server, a central location to accumulate enterprise-related content such as slide presentations, documents, images, and videos. Additionally, the system allows for event-tracking and custom content creation. This centralized content can be accessed from several security-enabled interfaces (client devices operated by enterprise, employees) including a desktop computer, slate computers, smart phones, all using a variety of operating systems (O.S.) including Windows-based O.S., an Android O.S., an iOS from Apple Computer, etc.

### I. FIELD OF THE INVENTION

The present invention relates generally to systems and methods for enterprise information dissemination to on-the-go employees to ensure company message coordination.

### II. BACKGROUND OF THE INVENTION

Large enterprises with many employees on the go—executives, sales and marketing personnel, technical personnel—may find it difficult to coordinate the dissemination of important information that enterprise employees would be well to have. For example, if at a trade show when a competitor releases a new press release bearing on his enterprise, an employee would benefit by be able to access that press release quickly, without knowing it exists and without having to conduct an Internet search for it, to be able to meaningfully respond to queries about the press release that may be posed.

Also, given the large number of potentially informative documents that an enterprise may wish for its employees to have available, present principles recognize that a document management system should be constructed to categorize documents, resource description framework (RDF) site summary (RSS) feeds, and the like according to what makes sense from the enterprise point of view. Still further, recognizing the ubiquitous use, of mobile computers in business settings with which to make presentations, demonstrate new products, and so on, present principles understand that ideally, the layout of the enterprise information presents a visually appealing, technically upscale appearance.

### SUMMARY OF THE INVENTION

Accordingly, a system is provided to coordinate information dissemination in a distributed enterprise such as a technical company. For executives, the present system can be used as the source for the most current company information for executives on the go. It can be used to prepare for business development, analyst and investor relations, meetings and media interviews, using travel time for studying current slide decks because the information is stored on the client device. The system allows prospects to touch and feel company technology during presentations by means of the advanced, rich user interfaces presented herein, and slide shows can easily be presented one-on-one or for larger groups using company technology. There is no need to sort through databases to get the most up-to-date and relevant information for the current need, and data aggregation and charting features allow for the exploration of trends and correlations (e.g., market share across geographies and vendors).

For sales and business development personnel, the system can be used to prepare sales and business development teams for customer and partner meetings and presentations by providing real time, rich media covering the latest messaging and product positioning, competitive intelligence and analyst reports, customer and partner presentations and videos, product data sheets and specifications, white papers, and return on investment (ROI)/financial assumption calculators. The system allows for sales teams to showcase products and capabilities in presentations.

For marketing and trade show staff, the system establishes a hub for the most current tradeshow, product, and brand information. The system also establishes an interactive sales and demonstration tool at events, allowing customers to directly interact and explore the application and mobile experience for themselves, while seeing all the company has to offer. The system makes great content more consumable and in higher demand and allows marketing and tradeshow teams to “walk the talk” of innovation by utilizing the most current company technology to talk about the company.

Accordingly, an enterprise computing device includes a processor, a display controlled by the processor, and a computer readable storage medium accessible, to the processor and bearing instructions executable by the processor to cause the display to present a top level user interface (UI) having at least three top level selector, elements. A first top level selector element may be a user role-based selector element such as an executive insight selector element, a second top level selector element may be a media selector element, and a third selector element may be a subject matter-based selector element such as a public relations selector element. As described in greater detail below the first top level selector element is selectable to cause a second level UI to be presented on the display presenting second, level selector elements respectively selectable to present on the display information related to messaging guidelines, investor relations, analyst-relations, and product briefs. In contrast, the second top level selector element is selectable to cause a second level UI to be presented on the display presenting second level selector elements respectively selectable to present on the display information related to video files available for presentation on the display and slide show presentations available for presentation on the display. On the other hand, the third top level selector element can be selected to cause a second level UI to be presented on the display presenting second level selector elements respectively selectable to present on the display information related to press releases and social media. If desired, each second level UI can include an information pane indicating a top level category to which the second level UI pertains, and the pane can also include a link selector element to return to the top level UI and link selector elements to respectively link to other top level categories.

In examples, the selector elements are overlaid onto a background image. If desired, the top level UI can present one and only one name of an enterprise associated with the top level categories.

In some embodiments the top level UI further includes a fourth top level selector element selectable to cause a second level UI to be presented on the display presenting second level selector elements respectively selectable to present on the display information related to trade shows, or to tiles, Venn models, drill downs, search fields, etc. The top level selector elements can be presented as bars arranged in a single row, or as bars arranged in a single column, or yet again as three dimensional parallelepipeds arranged in a single row, each floating above a respective disk.

In some implementations the processor causes a synchronization message to appear on the top level UI informing a user that content synchronization with a server has been completed along with a number of new documents downloaded during the synchronization, a number of documents that were updated during the synchronization, a number of RSS feeds that were updated during the synchronization. The processor may also download UI changes from a server and to this end the processor can periodically query a server for updated information.

In another aspect, an enterprise information management system for an enterprise includes an Internet computer server accumulating enterprise-related content including slide presentations, documents, images, flash files, and videos. The system allows for event-tracking and custom content creation. At least one client computing device accesses the content on the server, and the server provides the client device with an enterprise information application (EIA) executable by a processor of the client computing device to present nested user interfaces (UI) on a display of the client device. In this way, the server provides the enterprise-related content uniformly to client devices associated with the enterprise during synchronization events between the server and client devices such that employees of the enterprise using the client devices are presented with coordinated, consistent enterprise information while on the go.

In another aspect, a server implements a content management system (CMS) and includes a processor and a computer readable storage medium accessible by the processor to execute logic which includes determining whether an enterprise client device (ECD) has presented authorized credentials. Responsive to a determination that the ECD has presented authorized credentials, the logic includes downloading the ECD an enterprise information application (EIA) executable by the ECD to present a nested set of user interfaces (UI) useful for accessing enterprise-related content. The logic includes periodically receiving from the client device executing the EIA a signal to synchronize the enterprise-related content and UI layout of the ECD, and responsive to a determination that changes to the enterprise-related content have been made at the server since a most recent synchronization event with the ECD, downloading the changes to the ECD.

In another aspect, a computing device includes a processor, a display controlled by the processor, and one or more computer readable storage media accessible to the processor. The media store documents downloaded from a server, and the documents are associated with respective metadata indicating products and/or regions and/or audiences to which the documents pertain. Also, the media bear instructions executable by the processor to cause the display to present a user interface (UI) including a search selector element and selector elements enabling a user to input search terms related to products and/or regions and/or audiences. The processor returns an identification of documents from the media with metadata matching the search terms.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system according to present principles;

FIG. 2 is a flow chart of example initialization logic for configuring an enterprise client device to undertake present principles;

FIG. 3 is a flow chart of example client device synchronization logic;

FIG. 4 is a flow chart of example back end logic for updating enterprise content;

FIG. 5 is a block diagram of an example architecture of the enterprise information application (EIA);

FIG. 6 is an example screen shot presented by the enterprise control computer (ECC) to permit an administrator to add content to the enterprise content management system (CMS);

FIG. 7 is an example screen shot presented by an enterprise client device showing a top level user interface (UI);

FIG. 8 is an example screen shot presented by an enterprise client device showing a second level UI responsive to selection of “executive insight” from FIG. 7;

FIG. 9 is an example screen shot presented by an enterprise client device showing a third level UI responsive to selection of “regional messaging guide” from FIG. 8;

FIG. 10 is an example screen shot presented by an enterprise client device showing a third level UI responsive to selection of “analyst relations” from FIG. 8;

FIG. 11 is an example screen shot presented by an enterprise client device showing a fourth level UI responsive to selection of an analyst brief from FIG. 10;

FIG. 12 is an example screen shot presented by an enterprise client device showing a second level UI responsive to selection of “media” from FIG. 7;

FIG. 13 is an example screen shot presented by an enterprise client device showing a third level UI responsive to selection of “overview presentation” from FIG. 12;

FIG. 14 is an example screen shot presented by an enterprise client device showing a second level UI responsive to selection of “public relations” from FIG. 7;

FIG. 15 is an example screen shot presented by an enterprise client device showing a third level UI responsive to selection of “enterprise releases” from FIG. 14;

FIG. 16 is an example screen shot presented by an enterprise client device showing a third level UI responsive to selection of “competitor releases” from FIG. 14;

FIG. 17 is an example screen shot presented by an enterprise client device showing a third level UI responsive to selection of “technology business news” from FIG. 14;

FIG. 18 is an example screen shot presented by an enterprise client device showing a third level UI responsive to selection of “social media” from FIG. 14;

FIG. 19 is an example screen shot presented by an enterprise client device showing an alternate top level UI;

FIG. 20 is an example screen shot presented by an enterprise client device showing a second level UI responsive to selection of “executive insight” from FIG. 19;

FIG. 21 is an example screen shot presented by an enterprise client device showing a third level UI responsive to selection of “messaging guidelines” from FIG. 20;

FIG. 22 is an example screen shot presented by an enterprise client device showing a third level UI responsive to selection of “analyst relations” from FIG. 20;

FIG. 23 is an example screen shot presented by an enterprise client device showing a fourth level UI responsive to selection of an analyst briefing icon from FIG. 22;

FIG. 24 is an example screen shot presented by an enterprise client device showing a second level UI responsive to selection of “media” from FIG. 19;

FIG. 25 is an example screen shot presented by an enterprise client device showing a second level. UI responsive to selection of “public relations” from FIG. 19;

FIG. 26 is an example screen shot presented by an enterprise client device showing a second level, UI responsive to selection of “trade show” from FIG. 19;

FIG. 27 is an example screen shot presented by an enterprise client device showing a third level UI responsive to selection of a particular trade show from the list in FIG. 26;

FIG. 28 is an example screen shot presented by an enterprise client device showing yet another alternate top level UI; and

FIG. 29 is an example screen shot presented by an enterprise client device showing still another alternate top level UI.

### DETAILED DESCRIPTION OF THE PREFERRED EMBODIMENT

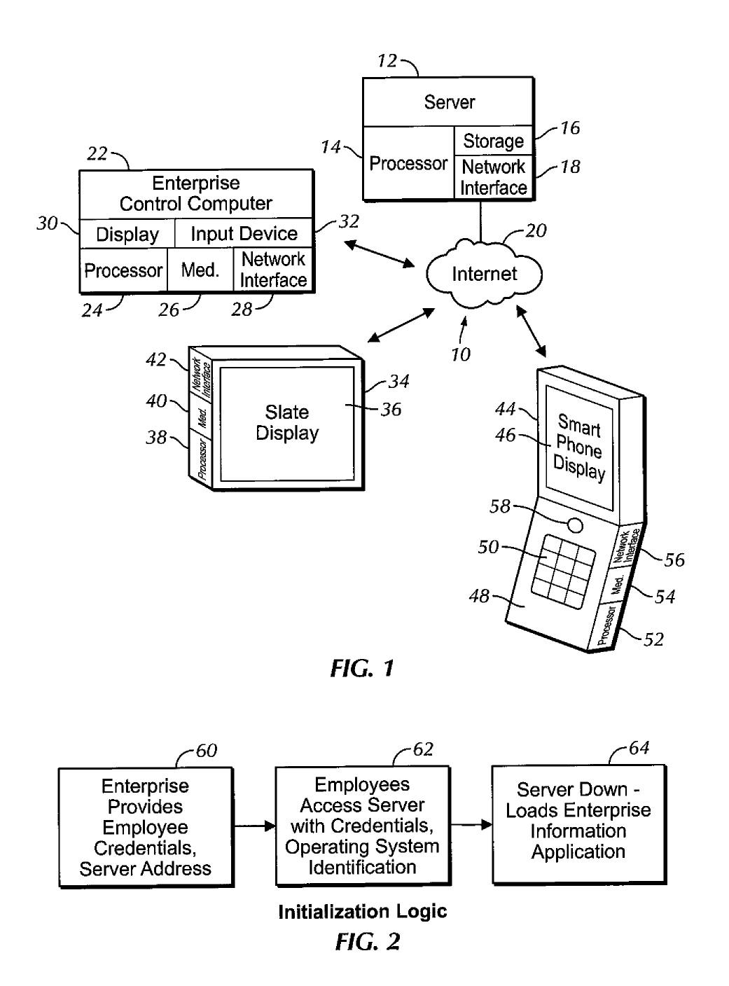

Referring initially to FIG. 1, a system is shown, generally designated 10, which includes one or more servers 12 having one or more digital server processors 14 accessing one or more computer readable storage media 16 such as disk-based or solid state storage to execute relevant logic herein. The media 16 also stores enterprise information content according to the description below for provision thereof to enterprise client devices. The server processor 14 communicates through a network interface 18 with the Internet 20.

Without limitation, the content that may be stored at the server 12 and disseminated to the client devices includes documents such as PDF documents, Word documents, and PowerPoint Presentations, rich media such as moving picture experts group (MPEG) video and flash video, scheduling descriptions including event description, event date and time and location, and an identification of supporting documents for the event, hypertext markup language (both HTML and HTML5) content including formatted text with bookmarked section headers, and social content such as social networking site feeds and other rich site summary (RSS) feeds.

The server processor(s) 14 accessing the server media 16 execute, for each enterprise that may wish to implement present principles, a respective content management system (CMS) according to logic herein. Each CMS is segregated at the server 12 from the CMS of other enterprises to provide only that information desired by an enterprise to the client devices of the enterprise, and no other information, e.g., from the CMS of other enterprises that may be hosted by the server 12.

An enterprise control computer (ECC) 22 is provided to load content into the server 12, create and delete user accounts, and to establish/define security requirements that are needed to access content. Also, the ECC allows administrators to create and update custom navigation menus for the clients, allowing enterprises to add, subtract, or change the function of UI sections. Essentially, as described further below the navigation menus are content buckets which guide users to the content they are looking for (e.g., Investor Relations, White Papers, Company News, Media Kits). As also described in further detail below, an enterprise information application (EIA) resident on each client device interfaces with the server 12 to provide rich user interfaces that synchronize with the server and download the content to be stored within the client device, allowing users to be able to access content when offline.

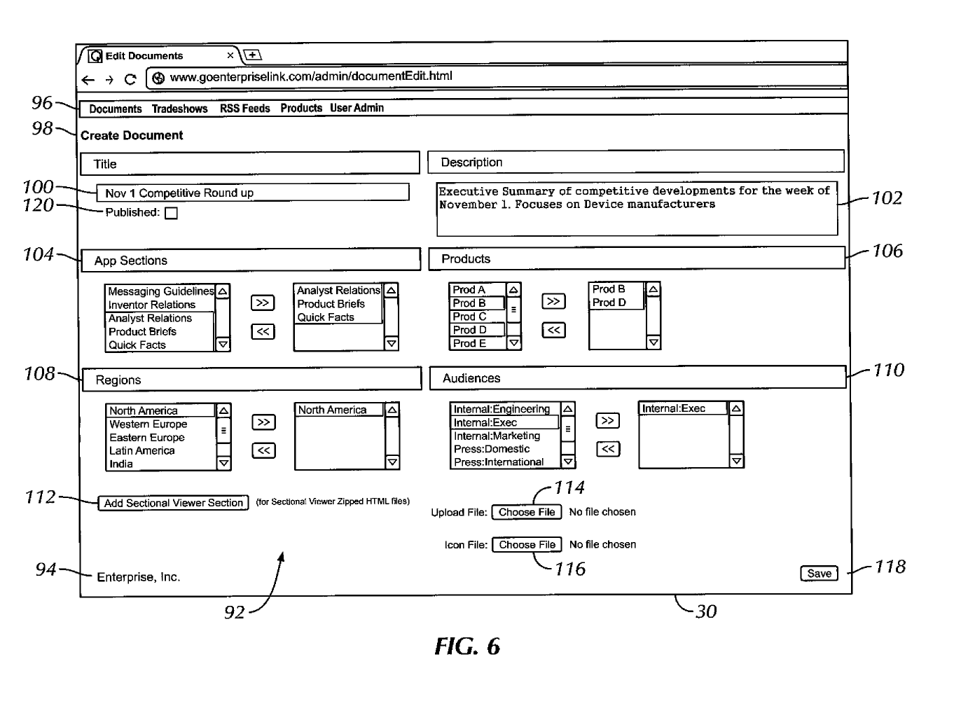

As shown in FIG. 1, the ECC includes one or more ECC processors 24 accessing one or more computer readable storage media 26 such as disk-based or solid state storage to execute relevant logic described herein. The ECC processor 24 communicates via a network interface 28 and Internet 20 with the server 12, as shown, and can output information including, e.g., the screen shot of FIG. 6 described below, on a video display 30. The ECC processor 24 can receive administrator input from one or more input devices 32 such as but not limited to keyboards, keypads, voice recognition systems, mice, joysticks, and the like. Without limitation, the network interfaces described herein may be implemented by any one or combination of wired or wireless modems, Wi-Fi transceivers, wireless telephony transceivers such as code division multiple access (CDMA) transceivers and variants thereof, global system for mobile communications (GSM) transceivers and variants thereof, orthogonal frequency division multiplex (OFDM) transceivers and variants thereof, and the like.

Content placed in the server 12 by an administrator operating, the ECC 22 is downloaded over the Internet 20 into enterprise client devices that may be variously configured with differing operating systems (O.S.) if desired. For example, a client device may execute a Windows-based O.S., an Android O.S., a Linux O.S., an iOS from Apple Computer Corp., a smart phone O.S. or other appropriate O.S.

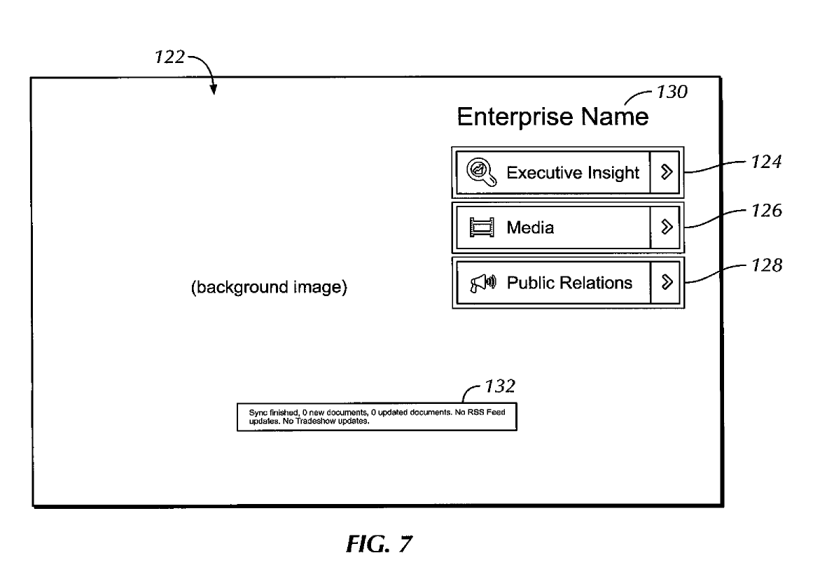

The enterprise client devices are computers, typically portable computers, that are operated by enterprise employees who may be on the go for business purposes. For example, a tablet computer 34 may establish an enterprise client, device (“client device”) and may include a touch-sensitive video display 36 presenting output from and sending input to one or more client device processors 38 accessing one or more computer readable storage media 40 such as disk based or solid state storage to execute relevant logic described herein, including presenting, on the display 36, the UIs shown in FIGS. 7-29. The slate computer 34 can communicate with the server 12 over the Internet 20 using a client device network interface 42.

Or, a smart wireless telephone 44 may establish an enterprise client device (“client device”) and may include a video display 46 foldably or otherwise movably engaged with or stationarily engaged with an input section 48 that may bear a telephone keypad or even full QWERTY keyboard 50. Using the keypad or keyboard 50 (and in embodiments in which the display 46 is a touch screen display, the display 46) a user can input commands to one or more client device processors 52 accessing one or more computer readable storage media 54 such as disk based or solid state storage to execute relevant logic described herein, including presenting, on the display 46, the UIs shown in FIGS. 7-29. The smart phone 44 can communicate with the server 12 over the Internet 20 using a client device network interface 56. The smart phone 44 may also include a still or video camera 58 sending signals to the processor 52 for presentation of images from the camera 58 on the display 46.

It is to be understood that while a slate computer 34 and smart-phone 44 are shown in FIG. 1 as illustrative examples of enterprise client devices, other devices may be used to establish an enterprise client device. For example, enterprise client devices may be established by laptop computers, notebook computers, personal digital assistants (PDAs), and even desktop computers.

Now referring to FIG. 2 for an understanding of how the enterprise information management system is initialized for a particular client device, at block 60 the enterprise provides to those employees it wishes to use the current system according to logic herein with personally unique credentials and the network address or identification of the enterprise CMS hosted on the server 12. These credentials are also provided to the server 12 to ensure that only authorized enterprise personnel may access the CMS of the enterprise that is hosted by the server 12. Note that the server 12 thus may host multiple CMS of respective enterprises, with each the content, RSS feeds; and navigation changes of each enterprise being segregated from that of other enterprises, in this example, by means of giving each CMS its own unique address with which client devices of the associated enterprise use to establish communications with their associated CMS.

Proceeding to block 62, a client device wishing to access the CMS of its enterprise provides credentials to the server 12, such as but not limited to user name and password. In some implementations the client device may also provide an identification of its O.S. to the server 12. Responsive to successful authentication of the client device credentials, at block 64 the server 12 downloads an enterprise information application (EIA) to the client device which is described further below as providing the UIs of FIGS. 7-20 and updating the client device with new information from the server 12. The EIA is tailored to the O.S. of the client device based on the identification of the O.S. provided at block 62. In this way, the server publishes only images and accompanying metadata (described further below) and then each individual EIA translates the images as appropriate for its native O.S. on the client device.

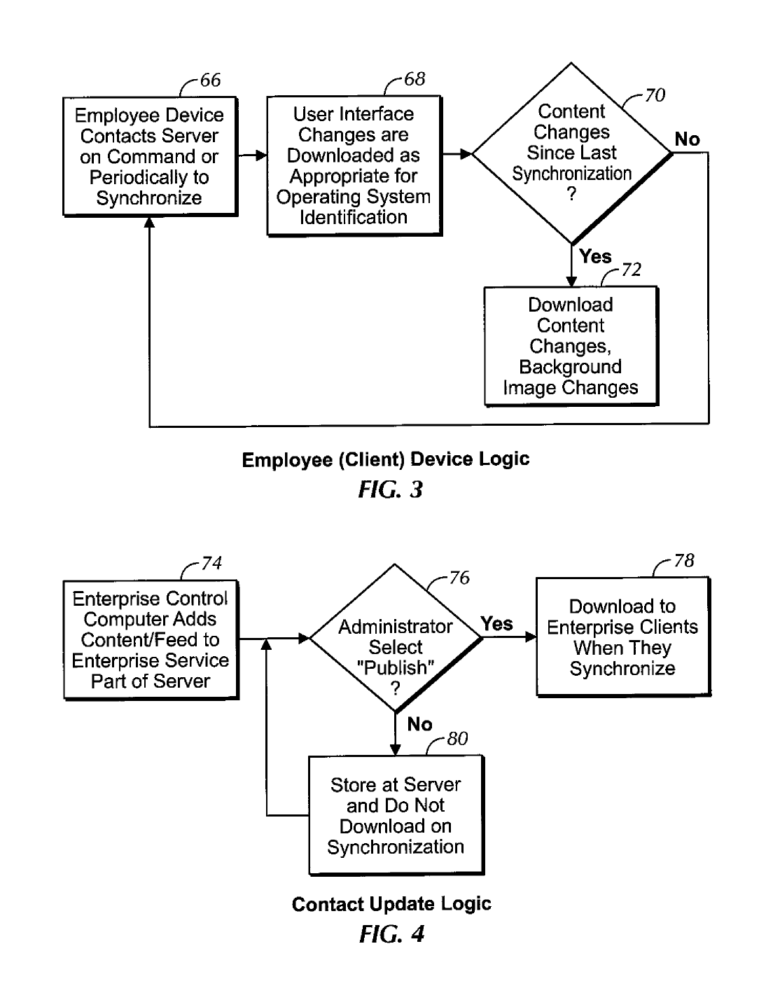

FIG. 3 illustrates example logic that may be executed by the EIA received at block 64 of FIG. 2. As shown, at block 66 the EIA executed by the client device processor contacts the enterprise CMS hosted by the server 12 periodically (e.g., automatically every hour or other period) and also upon manual user command to synchronize the content and UI layout of the client device with the CMS. Any changes to the UI that may have been entered into the CMS by an administrator operating the ECC 22 since the last synchronization are downloaded at block 68, configured as appropriate for the O.S. of the client device.

Proceeding to decision diamond 70 it is determined whether, in addition to any UI changes that may have occurred since the latest synchronization, any content changes (additions or deletions) have been implemented in the CMS. If so, those changes are downloaded at block 72, along with changes, if any, to the background image(s) over which the UIs may be overlaid. The logic then returns to block 66 to repeat the process for the next subsequent synchronization event.

Note that with the above-described synchronization, all desired CMS content is stored locally on each client device and is periodically updated on the client device, automatically if desired, so that the user of the client device can present the content to potential customers and the like regardless of whether the client device has Internet connectivity. Moreover, since each client device of the enterprise periodically synchronizes with the enterprise CMS, all client devices of the enterprise have the same information such that information dissemination to the client devices is coordinated and uniform.

In an example embodiment, the CMS simply downloads images of any new documents or updated documents along with their metadata, and the images are translated as appropriate for the native O.S. by each respective EIA. The metadata establishes searchable tags including, in one embodiment, tags related to location, product type, and audience type. Subsequently, when a user of a client device searches for a document, the tags are accessed and only documents with metadata matching the search terms are returned.

Turning to FIG. 4 for an overview of how content may be added to the CMS of an enterprise, at block 74 an administrator by means of the ECC 22 adds (or removes) content and/or RSS feeds from the enterprise CMS. However, while new content, for instance, may thus be resident on the server 12, it is not downloaded to synchronizing enterprise client devices until it is determined at decision, diamond 76, that the administrator has entered a “publish” command at the ECC 22, to control when enterprise employees may have access to the content. This may be desirable to ensure coordination of the enterprise by, for example, letting employees know about any new content and briefing them on how it should be handled or presented prior to downloading the content during the synchronizations.

After the administrator has published new content, it is downloaded to synchronizing client devices at block 78 during synchronization events. Otherwise, the content is stored, but not downloaded during synchronization events, at the server 12 at block 80.

In an example use case, assume that the enterprise CMS at the server 12 is publishing content to both Android O.S. and iOS client devices for the employees of an enterprise. These employees may currently have a public relations (PR) section with RSS feeds, and the enterprise decides to add a section on the UI titled “PR Documents” containing press releases. The change is made in the server, and when an employee's computer accesses the server it checks for content and UI changes. The new information is sent from the server to the client device in a consistent form and language across all the O.S. in the enterprise. At the client device level, executing the enterprise information application the client device interprets and expresses the new information by adding a new section called PR Documents with the capability of handling files types instead of simply RSS feeds.

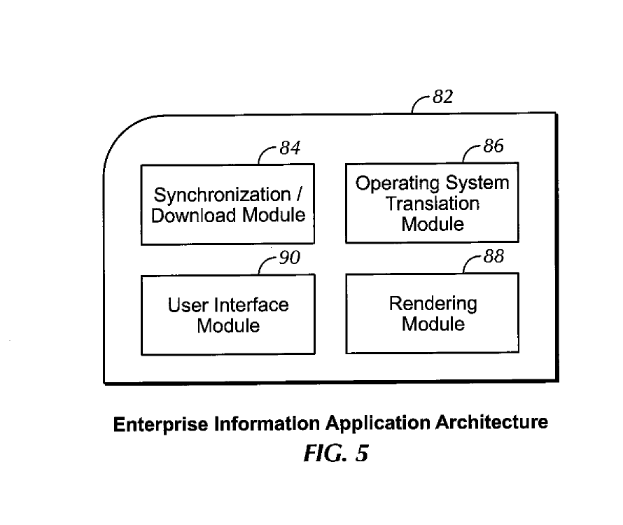

FIG. 5 illustrates a high level example architecture of an EIA 82 that may be downloaded to a client device at block 64 of FIG. 2, stored on the computer readable storage media of the client device, and executed by the processor of the client device. The EIA 82 may include a synchronization and download module 84 which, according to description above, periodically or on command contacts the enterprise CMS at the server 12 to download new content and UI information or to delete from the client device memory content that the CMS indicates should no longer be available on the client device.

An O.S. translation module 86 may also be provided in some implementations to translate, where necessary, content, RSS feeds, and navigation UI changes received from the CMS as appropriate for the native O.S. of the client device. Thus, for example, the translation module 86 may include an algorithm that transforms information published by the CMS for Windows-based devices to information suitable for a non-Windows based client device. Thus, each EIA is tailored for the O.S. for which it is used.

Additionally, the EIA 82 may include a rendering module 88 that renders images on the client device display according to present principles. For instance, the rendering module 88 may render a background image underlying the UIs of FIGS. 7-29 on the display of the client device. Then a UI module 90 generates and navigates UIs shown herein according to the description below.

Now turning to FIG. 6, a UI 92 is shown that can be presented on the display of the ECC 22 to add content to the CMS associated with the enterprise identified at 94 in FIG. 6. As shown in the selector tray 96, the administrator may select the category from which to select a document or to which to add a document, and any RSS feed wished to be added is identified in an “RSS feeds” section. The “user administration” section is used to enter the above-described metadata to associate that metadata with the document being added. The “products” section is used to add more product options to the metadata selection option.

As shown at 98 the administrator has selected to create a document with a title established by the administrator the field 100 and a short summary entered in a field 102.

The UI 92 also includes four sub-categorization areas, namely, a purpose section 104 (labeled “application sections” in FIG. 6), a products section 106, a regions section 108, and an audience section 110. The administrator may select one or more purposes from the purpose section 104 which essentially defines sections of the client device UIs discussed below in reference to FIGS. 7-29 from which the document may be accessed. In the example shown, the document is to be accessed from “analyst relations” tabs in the client device as well as from “product brief” and “quick facts” tabs.

On the other hand, the administrator may select one or more products to which the document applies which essentially defines product-related sections of the client device UIs discussed below in reference to FIGS. 7-29 from which the document may be accessed using the product section 106. In the example shown, products “A” and “B” have been associated with the document. Furthermore, the administrator may select geographic regions with which to associate the document in the regions section 108 which essentially defines geographic-related sections of the client device UIs discussed below in reference to FIGS. 7-29 from which the document may be accessed. In the example shown, the document has been associated with “North America”. Still further, the administrator may select audiences to whom the document pertains in the audiences section 110, which essentially defines audience-related sections of the client device UIs discussed below in reference to FIGS. 7-29 from which the document may be accessed. In the example shown, the document has been associated with “internal executives”, meaning executives internal to the enterprise, although it could also have been associated with internal (enterprise only) engineering, internal (enterprise only) marketing, domestic press, and international press.

In addition, the administrator may select to add a sectional viewer section for section viewer zipped files by selecting a sectional viewer selector element 112. The administrator may select to upload a file (from a website, internal storage, etc.) with which to establish the content of the document by selecting an upload selector element 114, and likewise can establish an icon image to be associated with the document on the client devices by means of an icon selector element 116. The selections may be saved by selecting a “save” element 118 and published as discussed above in reference to FIG. 4 by selecting a publish selector element 120.

FIGS. 7-18 show a first set of screen shots that may be presented on a display of an enterprise client device. In the top level UI 122 of FIG. 7, three rectangular-shaped category selector elements with associated icons are listed in a column along the right side of the UI. Specifically, an executive insight selector element 124 is shown above a media selector element 126, which in turn is above a public relations selector element 128. The selector elements may be overlaid onto a background image 130 which may be a moving or still picture that is established by the administrator operating the ECC 22. The name of the enterprise may be shown, e.g., in the upper right hand corner of the UI above the selector elements, as indicated at 130.

In the embodiment shown in FIG. 7, a synchronization message also appears in a window 132, informing the user that synchronization has recently been completed along with the number of new documents downloaded during the synchronization, the number of documents that were updated during the synchronization, the number of RSS feeds that were updated during the synchronization, and the number of tradeshow-related documents were updated during the synchronization. In the event that any new documents were downloaded, the titles of those documents may be presented on the client device display and identified as “new”. Likewise, if any documents were updated, the titles of those documents are also listed on the display and identified as “updated”.

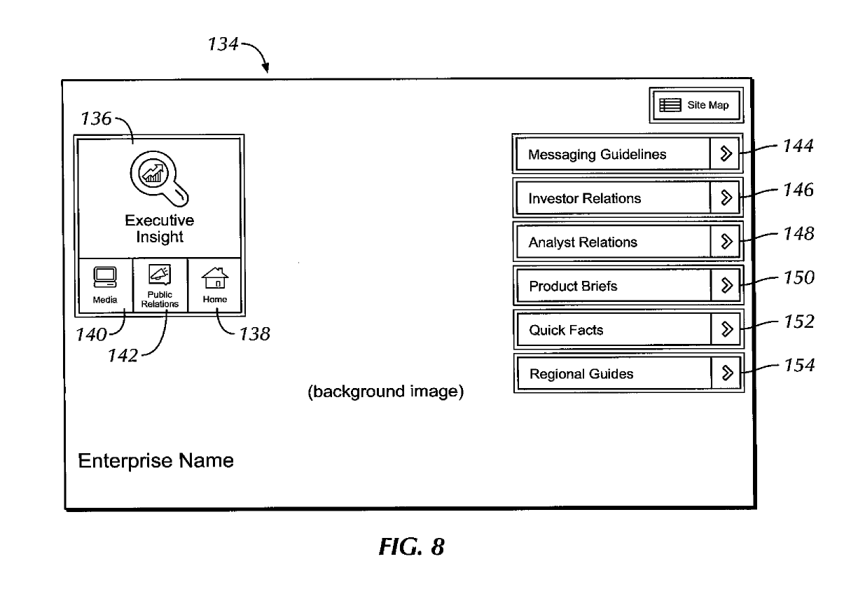

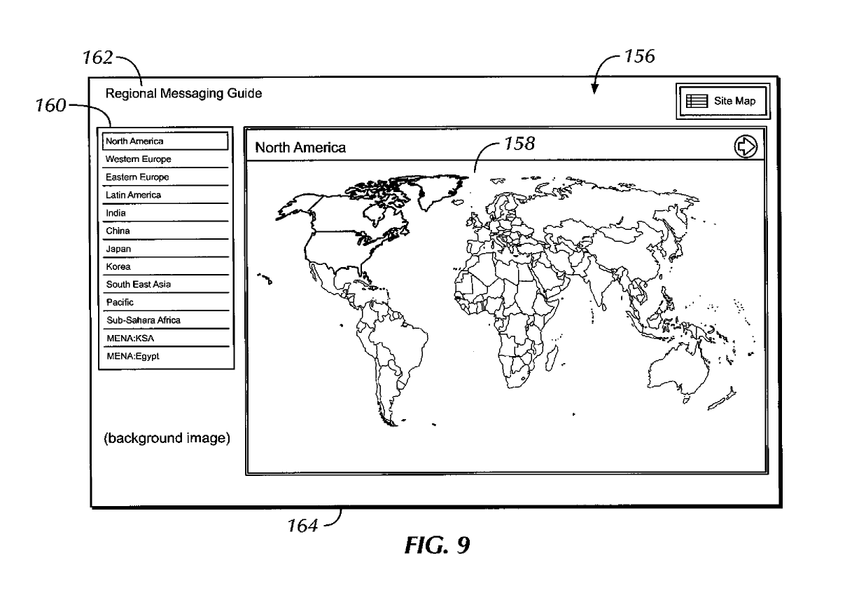

Selection of the executive insight selector element 124 invokes the UI 134 of FIG. 8, which shows, in an information pane 136 that may be positioned at the left side of the UI, the upper level category to which the UI 124 pertains, in this case, to executive insight. Note that the pane 136 may also include a direct link selector element 138 to return to the UI of FIG. 7, and direct link selector elements 140, 142 which link directly to the other top level two categories shown in FIG. 7 as depicted in FIG. 8.

Arranged in a column on the right side of the example UI 134 in FIG. 8 are third level selector elements 144-154 respectively selectable to return additional information regarding messaging guidelines (advice on enterprise messages that are, and are not, to be delivered to the relevant public), investor relations (information related to investment in the enterprise, briefings for investors), analyst relations (information related to analyst reports, company ratings, briefings for analysts, etc.), product briefs (information typically in summary form related to enterprise products, typically on a product by product basis), quick facts (highly important sales information) and regional messaging guides (messaging guides by geographic region).

By way of example, assume the regional messaging guide selector 154 is selected from the UI 134 of FIG. 8. An example third level. UI 156 that may be invoked thereby is shown in FIG. 9. As shown, the example UI 156 may include a map 158 of geographic regions which may be clicked on to cause messaging guides pertaining to that region to be presented on the display. In addition, the UI 156 may include a column 160 of selector elements each representing a respective geographic region that may be selected for the same purpose as clicking on a desired portion of the map 158. The title of the UI 156 is shown at 162.

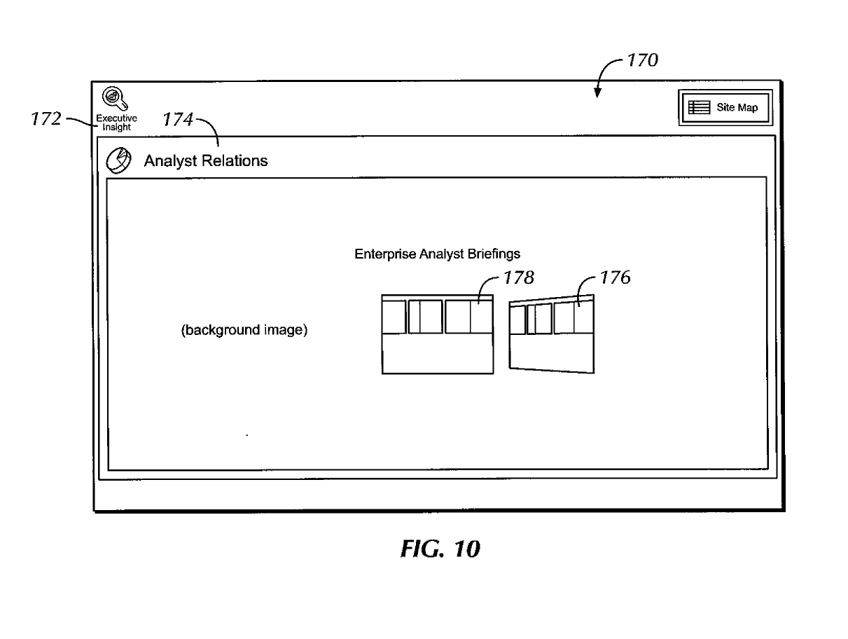

On the other hand, if the analyst relation selector 148 is selected from the UI 134 of FIG. 8, a UI 170 shown in FIG. 10 may be presented on the display. As shown, the example UI 170 includes, at 172, the name of the top level UI selection (in this case, executive insight) as well as, at 174, the name of the second level selection (in this case, analyst relations). Each name may be accompanied by a respective icon as shown.

In the example UI 170, selectable images 176 (image being turned) and 178 (image facing full forward) indicate that animation may be used to transition between UIs. In the example shown, only a single sub-category titled “analyst briefings” is available. While the images 176 and 178 are shown appearing simultaneously on the screen, it is to be understood that a single animated image, turning from a sideways to a full frontal orientation, may be presented.

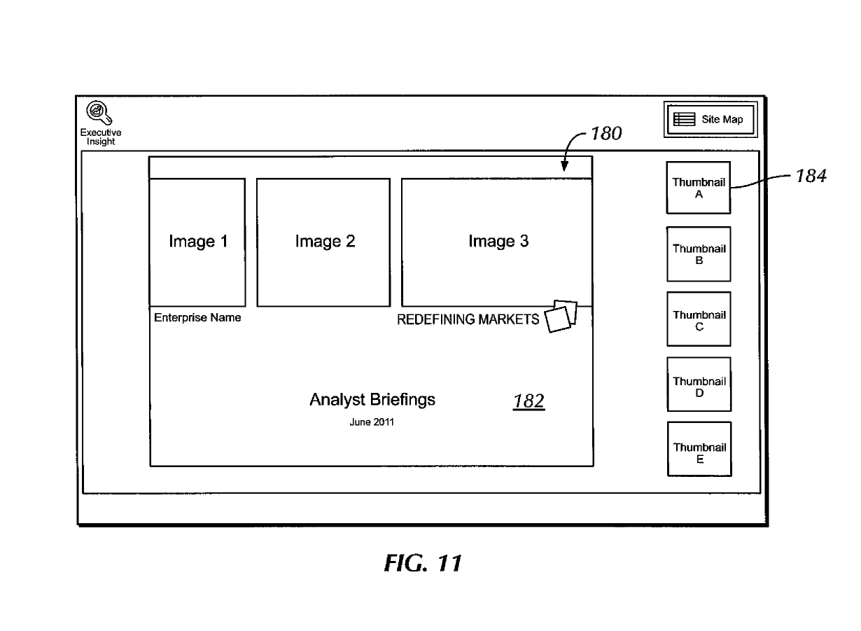

Assume the image 176 is selected. This invokes, in one example, the UI 180 shown in FIG. 11, which in the example shown is a slide show with the main slide in focus being presented in a large central window 182 and with thumbnail selectable images 184 appearing a column next to the central window 184. In this way, the user can have drilled down, from the UI in FIG. 7 through intervening levels to the slide show shown in FIG. 11 to present the slide show to analysts. It is to be understood that alternatively, the image in the central window 182 may be selected to cause a respective slide show to be presented and the thumbnails 184 may each be selected to cause a respective slide show associated with that thumbnail to be presented.

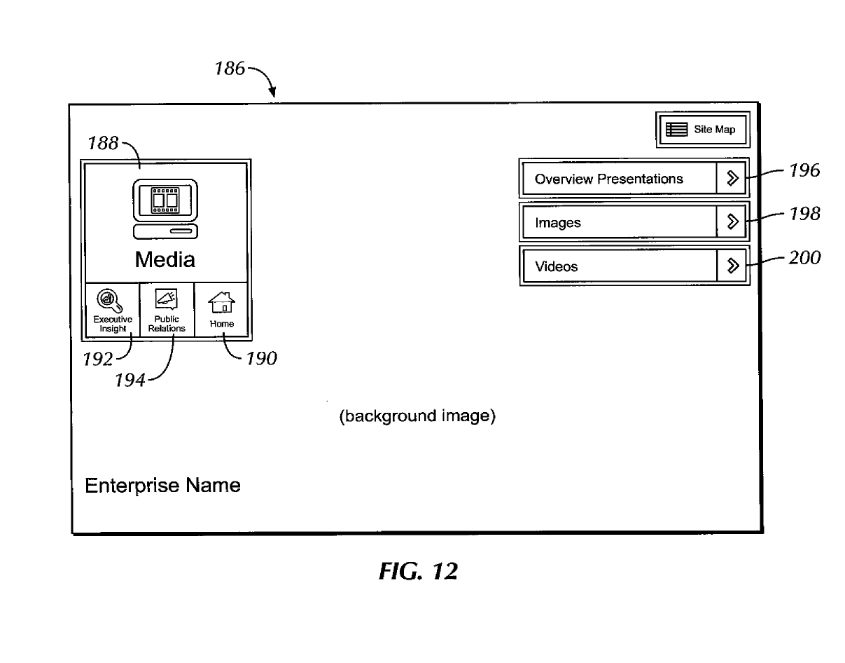

Return to FIG. 7 and assume that the media selector 126 is selected. This causes, in one example implementation, the UI 186 of FIG. 12 to appear. As was the case with the second level UI 134 of FIG. 8, the UI 186 in FIG. 12 includes an information pane 188 that may be positioned at the left side of the UI, indicating the upper level category to which the UI 186 pertains, in this case, to media. Note that the pane 188 may also include a direct link selector element 190 to return to the UI of FIG. 7, and direct link selector elements 192, 194 which link directly to the other top level two categories shown in FIG. 7 as depicted in FIG. 12.

Arranged in a column on the right side of the example UI 186 in FIG. 12 are third level selector elements 196-200 respectively selectable to return additional information regarding overview presentations (typically, slide shows), still images, and videos, all of which, like the other content available with the UIs of FIGS. 7-18, are downloaded as part of the synchronization process from the enterprise CMS hosted at the server 12.

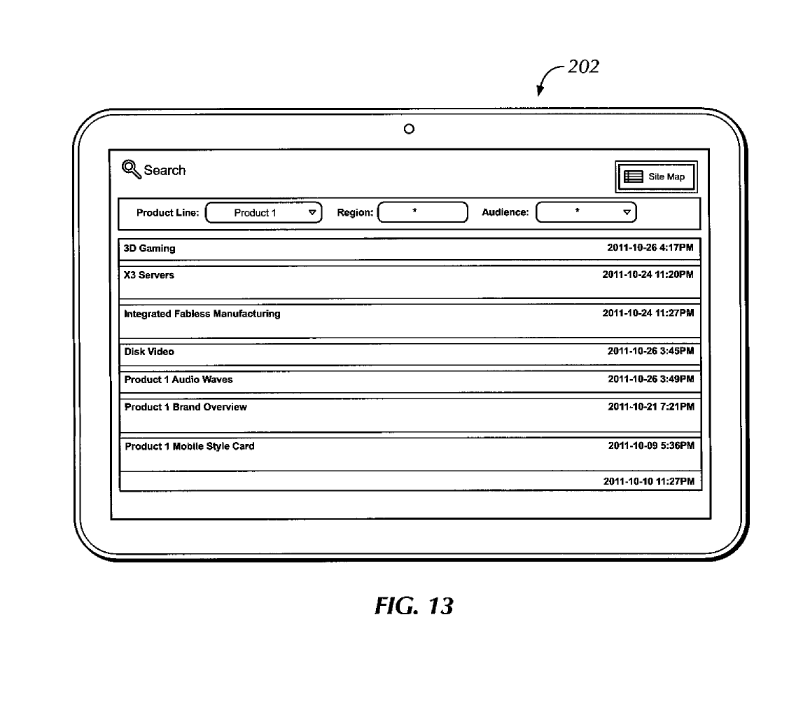

By way of non-limiting example, if the overview presentations selector 196 is selected from the UI 186 of FIG. 12, the UI 202 shown in FIG. 13 may be presented, listing by title various overview presentations available onboard the client device, having been downloaded from the enterprise CMS. Selection of an entry in the UI 202 causes the underlying overview presentation, be it a slide show a video, an audio track, etc. to be played on the client device. Other categories may include manuals, automatic aggregation of a particular file type, RSS feed aggregator, social media feed aggregator, graphs, charts, tools.

Note that at the top of the UI 202 in FIG. 13 a search selector is presented along with a row of three drop-down menus labeled “product”, “region”, and “audience”. Recall that as disclosed above, the CMS can download images of documents along with their metadata which establishes searchable tags including tags related to location, product type, and audience type. It may now be appreciated that the “product”, “region”, and “audience” menus contain respective lists of products, geographic regions, and audiences (e.g., executives only, sales team, customers, individual corporate account, etc.) and a user can select an entry from each menu for a narrower search or from only a subset of the menus, for a broader search. Then, the user can select the “search” selector. This causes the processor to search for downloaded documents by accessing the metadata tags of the documents which match the search terms input by means of the above-described menus. The processor returns, in a list or other data structure, for example, that can be presented on the display of the client device, only documents with metadata tags matching the search terms input by means of the menus.

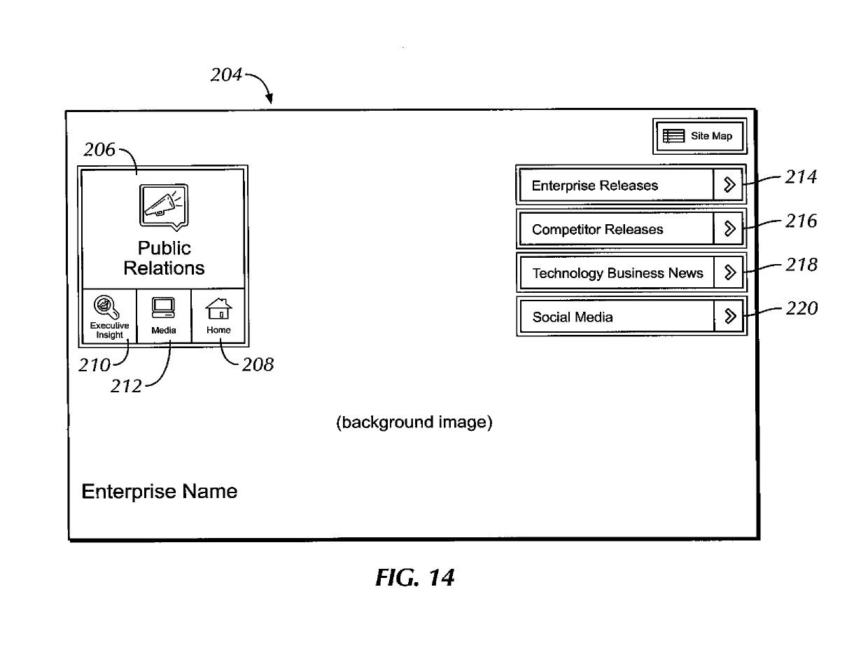

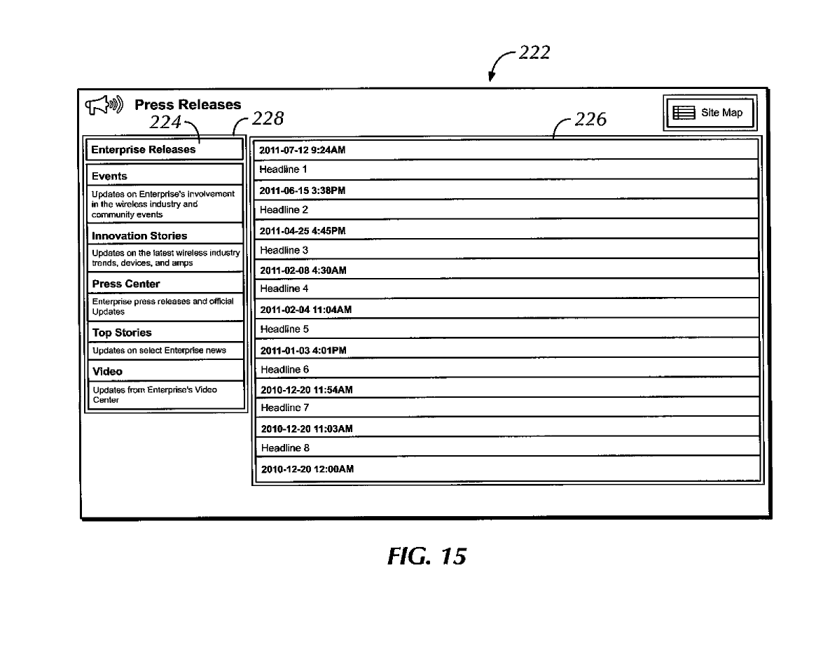

Return to FIG. 7 and assume that the public relations selector 128 is selected. This causes, in one example implementation, the UI 204 of FIG. 14 to appear. As was the case with the second level UI 134 of FIG. 8, the UI 204 in FIG. 15 includes an information pane 206 that may be positioned at the left side of the UI, indicating the upper level category to which the UI 204 pertains, in this case, to public relations. Note that the pane 206 may also include a direct link selector element 208 to return to the UI of FIG. 7, and direct link selector elements 210, 212 which link directly to the other top level two categories shown in FIG. 7 as depicted in FIG. 14.

Arranged in a column on the right side of the example UI 204 in FIG. 14 are third level selector elements 214-220 respectively selectable to return additional information regarding enterprise press releases (a list of selectable press releases from the enterprise), competitor press releases (a list of selectable press releases from enterprise-designated competitors) technology business news (list of selectable articles related to technology business), and social media (list of available social media feeds, including competitor social media feeds and enterprise feeds).

Assume that the enterprise releases selector 214 is selected in FIG. 14. This causes the UI 222 of FIG. 15 to appear, which in the example shown contains two columns 224, 226 of selectable items. The left hand column 224, which also includes, at 228, the title of the UI (in this case, enterprise releases), includes press release genre selections selectable to cause only releases in the selected genre to appear in the column 226. When the main title 228 is selected all enterprise press releases appear in the column 226. Selection of a title in the column 226 causes the underlying press release to appear onscreen in text format or video format or audio format, according to the format of the release.

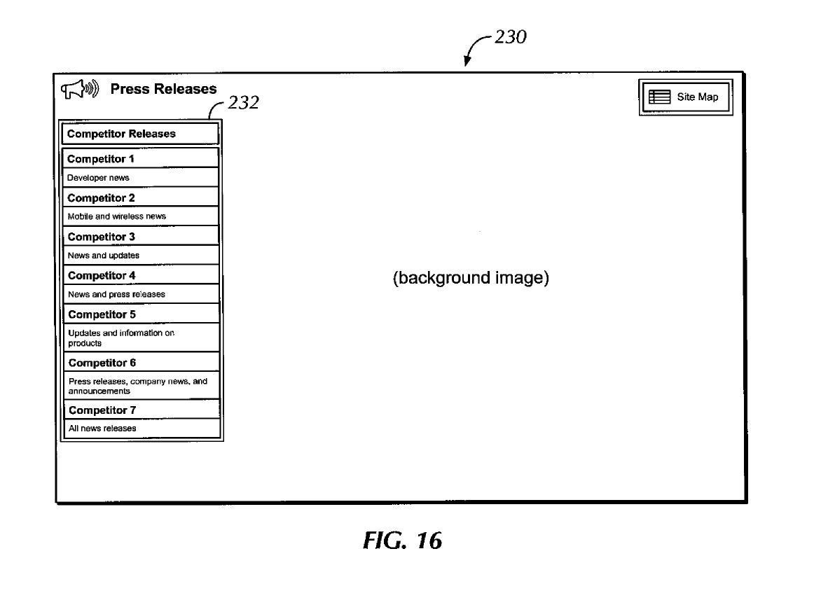

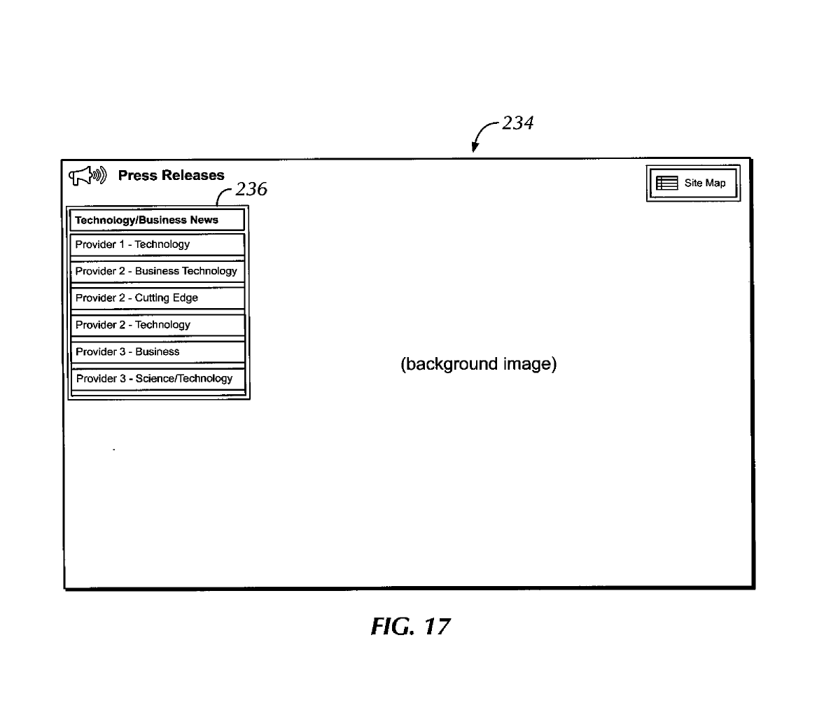

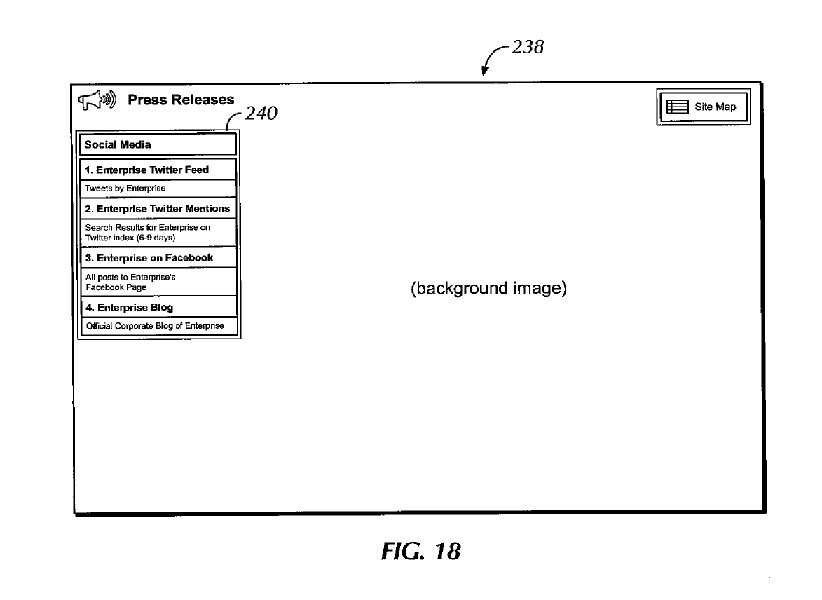

When the competitor releases selector 216 of FIG. 14 is selected, the UI 230 of FIG. 16 appears, showing, in a column 232, a list of competitors from which a competitor may be selected to view its press releases. On the other hand, when the technology business news selector 218 of FIG. 14 is selected, the UI 234 of FIG. 17 appears, showing, in a column 236, a list of technology news feeds and/or articles by source as shown, one of which may be selected to cause underlying news material to be presented on the client device. Yet again, when the social media selector 220 of FIG. 14 is selected, the UI 238 of FIG. 18 appears, showing, in a column 240, a list of social network RSS feed, one of which may be selected to cause underlying RSS feed to be presented on the client device.

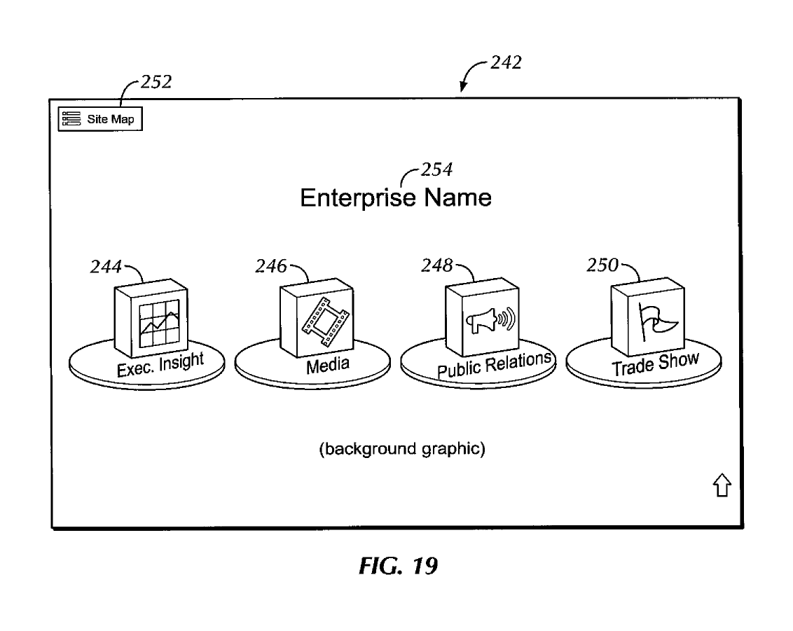

FIGS. 19-27 show an alternate set of UIs similar to those shown in FIGS. 7-18 but with differing appearances and in some cases somewhat different UI categories and/or selectors. Note that the UIs of FIGS. 19-27 may be initially downloaded to a client device with the EIA at block 64 of FIG. 2, or may be downloaded as an updated UI at block 68 of FIG. 3, by downloading instructions to the EIA to change the graphics rendering to conform to the appearances of FIGS. 19-27.

A top level UI 242 is shown in FIG. 19 showing perspective views of four selector elements 244-250 arranged in a row and shaped as labeled colored parallelepipeds floating above respective flat disks as shown. Similar to the UI 122 of FIG. 7, the UI 242 of FIG. 19 includes selector elements for executive insight, media, and public relations, having the same functions as the corresponding selector elements in FIG. 7. However, the top level UI 242 of FIG. 19 also includes a trade show selector element 250 selectable to cause a second level trade show-related UI to appear on the display as described further below. Other than a site map selector 252, selectable to cause a site map of the EIA to be presented, and the bottom tool tray, and the enterprise name 254, the UI 242 includes no other information that might otherwise clutter the presentation.

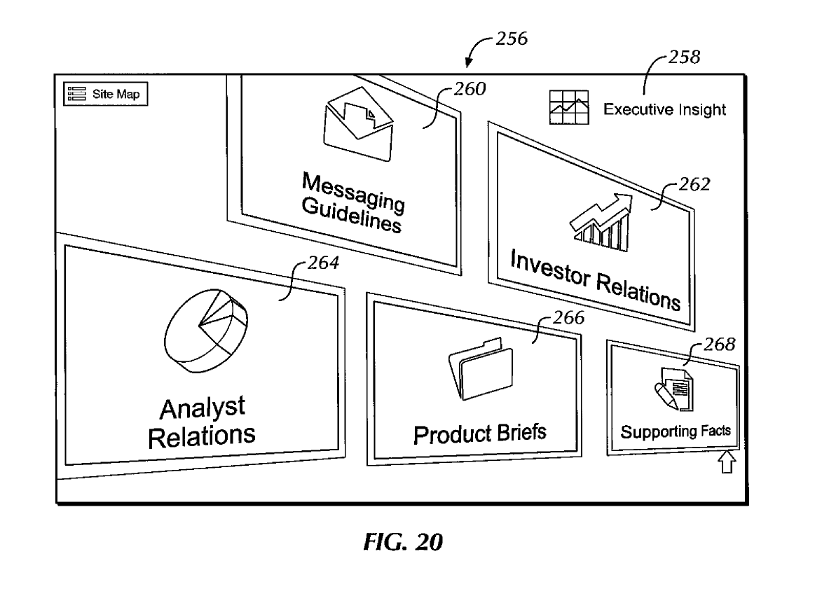

When the executive insight selector 244 is selected in the UI 242 of FIG. 19, the UI 256 of FIG. 20 is presented. The UI 256 shows a label 258 indicating the upper level category to which the UI 256 pertains, in this case, to executive insight. Arranged in two rows of two and three respectively and shown rotated away from a face-on perspective to an oblique perspective are third level selector elements 260-268 respectively selectable to return additional information regarding messaging guidelines (advice on enterprise messages that are, and are not, to be delivered to the relevant public), investor relations (information related to investment in the enterprise, briefings for investors), analyst relations (information related to analyst reports, company ratings, briefings for analysts, etc.), product briefs (information typically in summary form related to enterprise products, typically on a product by product basis), and supporting facts (information related to interesting facts about the enterprise, such as when it was founded, who the CEO is, last quarter sales, etc.).

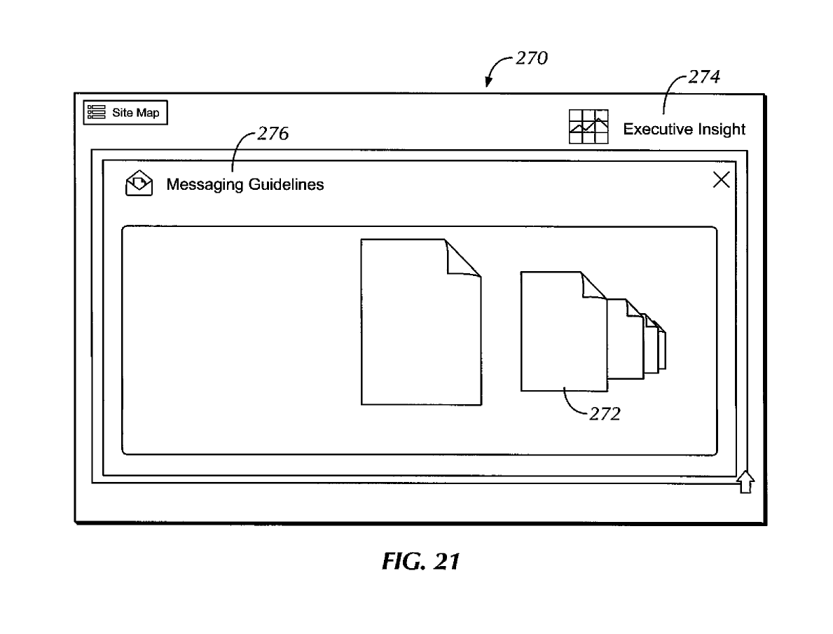

Assume the messaging guide selector 260 is selected from the UI 256 of FIG. 20. An example third level UI 270 that may be invoked thereby is shown in FIG. 21. As shown, the example UI 270 may include images 272 of single pages, some of which partially overlay each other, with the single page images growing successively smaller to emulate the images being disposed successively further away from the viewer. If desired, as shown the upper right corner of each page may be folded down. Each image 272 contains a title of a subject for which messaging guidelines will be presented on the display responsive to selection of that image. Both the associated top level UI name 274 and associated second level UI name 276 can be presented on the third level UI 270 as shown for convenient reference for the user.

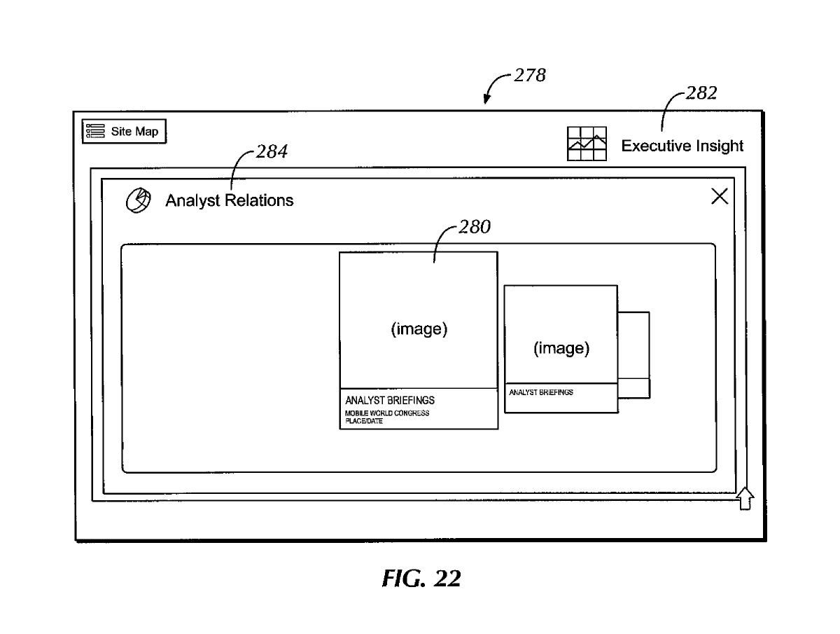

Now assume the analyst relations selector 264 is selected from the UI 256 of FIG. 20. An example third level UI 278 that may be invoked thereby is shown in FIG. 22. As shown, the example UI 278 may include images 280 of single pages each with the same background image, e.g., a still photo, if desired, some of which partially overlay each other, with the single page images growing successively smaller to emulate the images being disposed successively further away from the viewer. Each image 280 contains a title of a subject for which messaging guidelines will be presented, on the display responsive to selection of that image; when only a single briefing file is present, each image may present the same title as other images, and selection of any image will open the single briefing file. Both the associated top level UI name 282 and associated second level UI name 284 can be presented on the third level UI 278 as shown for convenient reference for the user.

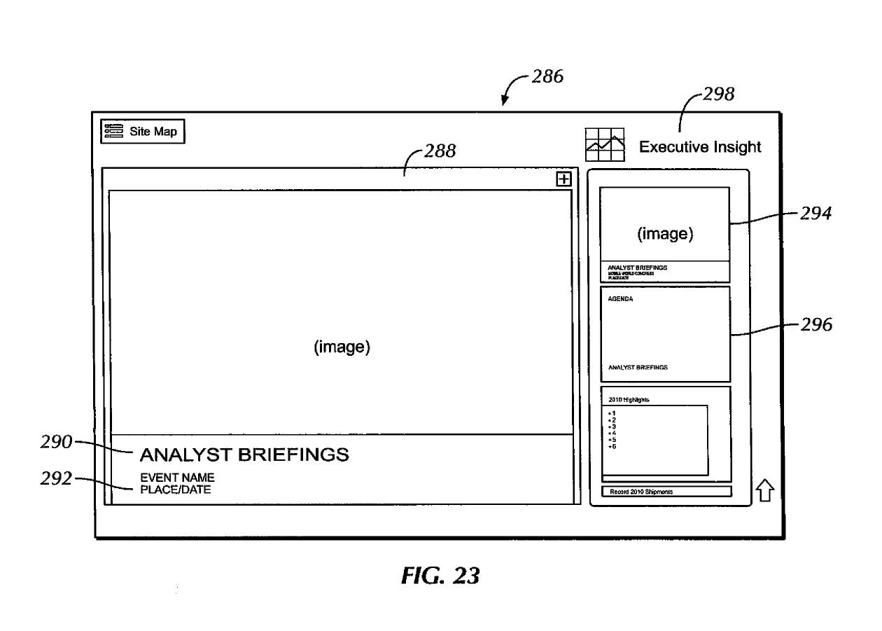

For an example of a fourth level UI, assume one of the images 280 in FIG. 22 has been selected. The example UI 286 of FIG. 23 may be presented in response. As shown, the UI 286 includes a large pane 288 with the title 290 of the second level UI and title 292 of the particular briefing. To the right of the large pane 288 is a smaller pane 294 containing thumbnail images 296 of pages or slides within the briefing. The name 298 of the top level UI may be presented if desired above the smaller pane 294.

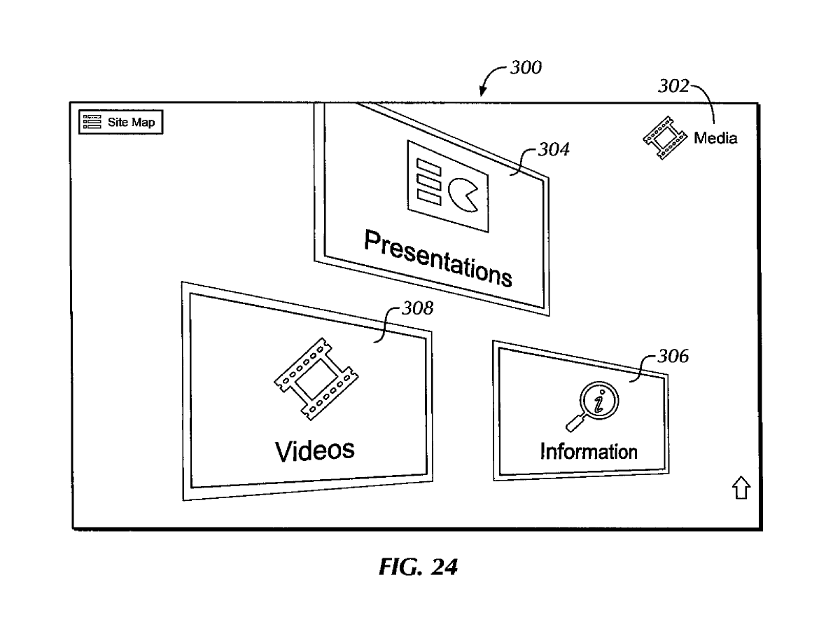

Returning to FIG. 19, responsive to selection of the media selector element 246, a second level media UI 300 may be presented on the client device display as shown in FIG. 24. As shown at 302 the upper level category to which the UI 300 pertains, in this case, to media, is indicated. Arranged in a triangular pattern are third level selector elements 304, 306, 308 respectively selectable to return additional information regarding overview presentations (typically, slide shows), information documentation, and videos, all of which, like the other content available with the UIs, can be downloaded as part of the synchronization process from the enterprise CMS hosted at the server 12. The elements 304-308 may be depicted rotated away from a face-on perspective to an oblique perspective as shown.

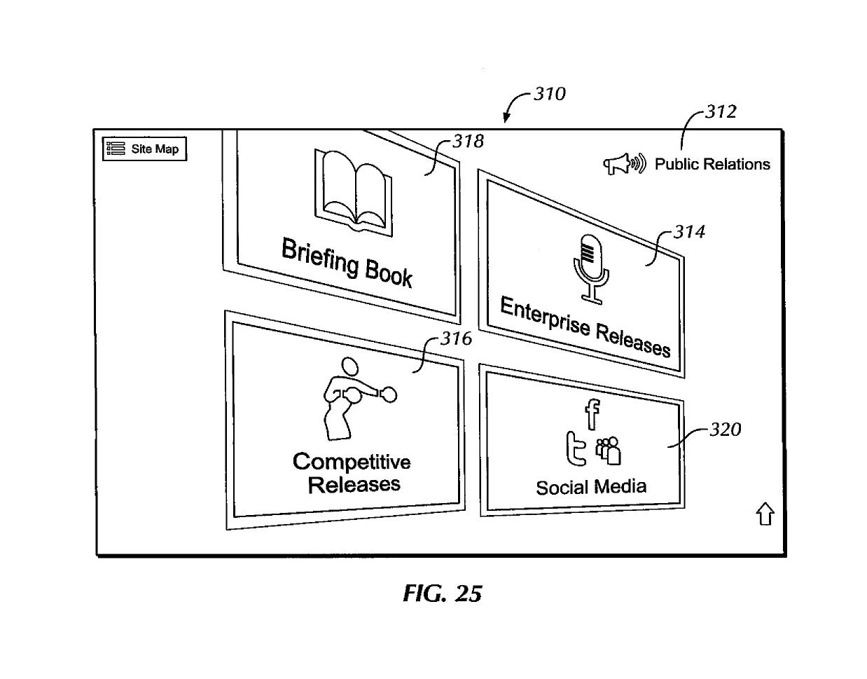

In contrast, when the public relations selector 248 is selected from FIG. 19, the UI 310 of FIG. 25 may be presented. As shown at 312 the upper level category to which the UI 310 pertains, in this case, to public relations, is indicated. Arranged in two rows of two selector elements each are third level selector elements 314-320, respectively selectable to return additional information regarding enterprise press releases (a list of selectable press releases from the enterprise), competitor press releases (a list of selectable press releases from enterprise-designated competitors) briefing book (list of briefings such as slide shows related to business or technology briefs to analysts, sales force personnel, etc.), and social media (list of available social media feeds, including competitor social media feeds and enterprise feeds). The elements 314-320 may be depicted rotated away from a face-on perspective to an oblique perspective as shown.

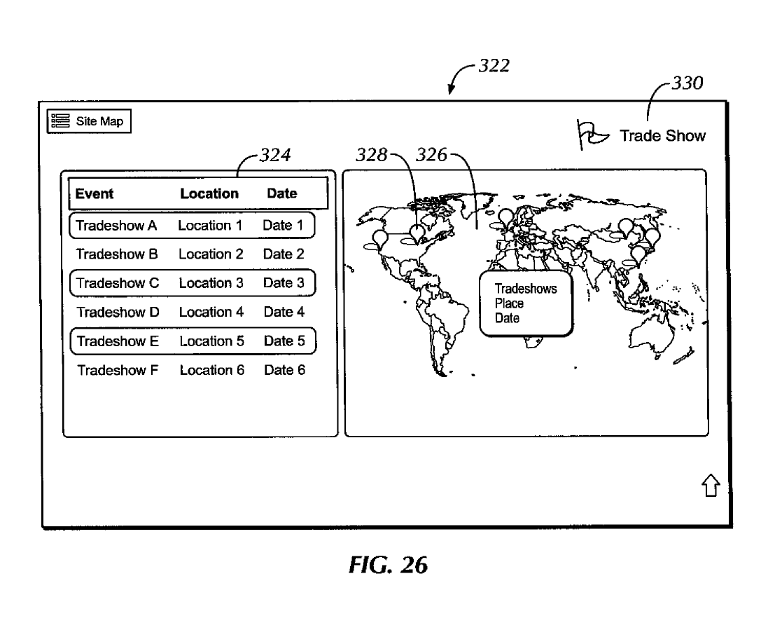

Should the trade show selector element 250 of FIG. 19 be selected from the top level UI 242, an example second level trade show UI 322 as shown in FIG. 26 may be presented on the display of the client device. As shown, a list pane 324 may be presented on the left side of the UI 322 with selector elements arranged in a column, with each displaying metadata related to a respective trade show (name, location, and date of the trade show) and each being selectable to cause further information related to the trade show to be presented. Also, to the left of the list pane 324, a map 326 may be presented showing locations 328 of the trade shows listed in the pane 324. The name 330 of the top level category may also be presented, in this case, “trade show”.

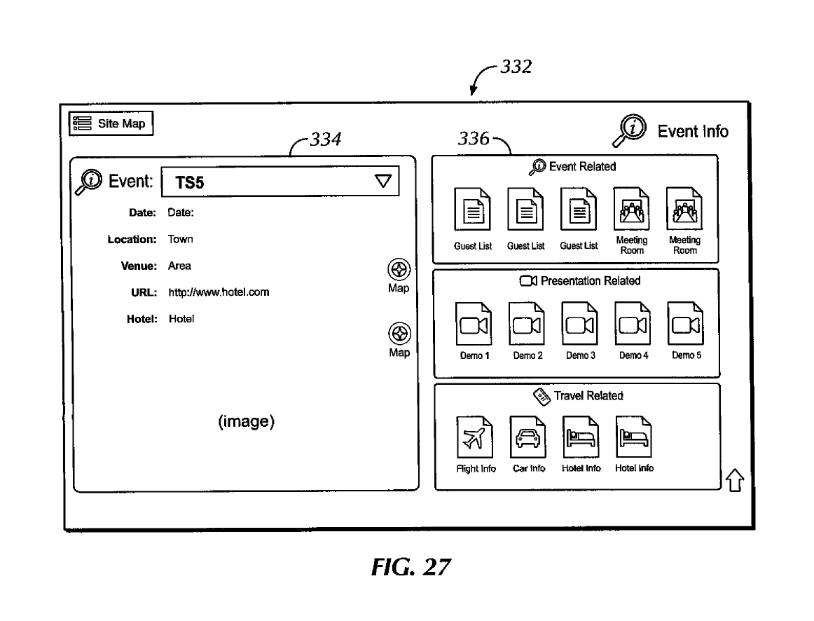

Should a trade show selector element from the pane 324 in FIG. 26 be selected, a third level UI 332 may be presented as shown in FIG. 27 providing further information related to the trade show associated with the selected element from the pane 324. A metadata pane 334 may be presented on the left part of the display setting forth metadata related to the tradeshow, e.g., title, date, location, venue, website address, and a hotel that may be affiliated with the trade show. A document window 336 may be presented next to the metadata pane 334 if desired showing rows of thumbnails that may be selected to cause respective documents or other information related to the trade show to be presented on the display. For example, guest lists and meeting room names, slide show demonstrations, and travel related information may be accessed by clicking on an appropriate thumbnail in the window 336.

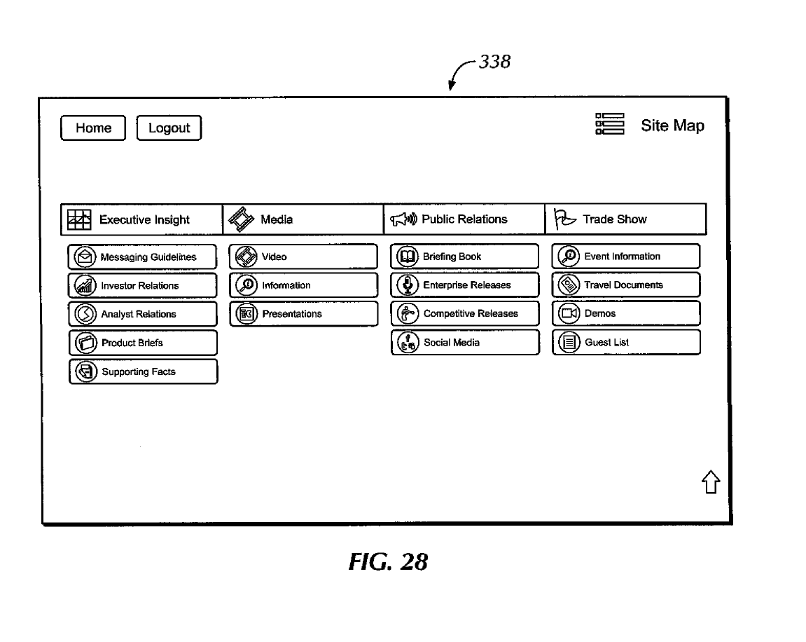

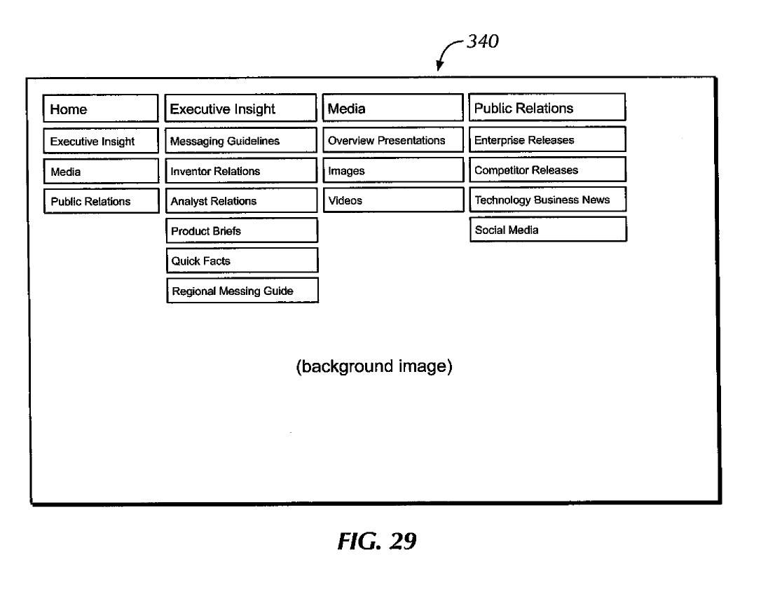

FIGS. 28 and 29 are alternative top level UIs 338, 340 that may be presented which present not only selector elements for the top level categories, but also selector elements for the respective second level categories. It is to be understood that FIG. 28 or 29 may be presented when a user selects “site map” from the UIs shown in the figures described above. In FIG. 28, the same four top level categories that are depicted in FIG. 19 are shown, arranged in a row with the title and an associated icon for each category. In a column below each top level category is a list of selector elements for each associated second level category. Section of the various categories may cause the client device to present third level UIs in accordance with principles above.

FIG. 29 is similar to FIG. 28 except only the three top level categories that were shown in FIG. 7 appear in FIG. 29.

While the particular SYSTEM AND METHOD FOR ENTERPRISE INFORMATION DISSEMINATION is herein shown and described in detail, it is to be understood that the subject matter which is encompassed by the present invention is limited only by the claims.

1. Computing device comprising:
processor;
display controlled by the processor; and
computer readable storage medium accessible to the processor and bearing instructions executable by the processor to cause the display to present a top level user interface (UI) having at least three top level selector elements,
a first top level selector element being a user role-based selector element, a second top level selector element being a media selector element, and a third selector element being a subject matter-based selector element,
the first top level selector element being selectable from the top level UI to cause a second level UI to be presented on the display presenting second level selector elements respectively selectable to present simultaneously on the display at least information related to messaging guidelines, investor relations, analyst relations, and product briefs,
the second top level selector element being selectable from the top level UI to cause a second level UI to be presented on the display presenting simultaneously second level selector elements respectively selectable to present on the display at least information related to video files available for presentation on the display and slide show presentations available for presentation on the display,
the third top level selector element being selectable from the top level UI to cause a second level UI to be presented on the display presenting simultaneously second level selector elements respectively selectable to present on the display at least information related to press releases and social media.

2. The device of claim 1, wherein the selector elements are overlaid onto a background image.

3. The device of claim 1, wherein the top level UI presents one and only one name of an enterprise associated with the top level selector elements.

4. The device of claim 1, wherein the top level UI further comprises a fourth top level selector element selectable to cause a second level UI to be presented on the display presenting second level selector elements respectively selectable to present on the display at least information related to trade shows.

5. The device of claim 1, wherein the top level selector elements are presented as bars arranged in a single row.

6. The device of claim 1, wherein the top level selector elements are presented as bars arranged in a single column.

7. The device of claim 1, wherein the top level selector elements are presented as three dimensional parallelepipeds arranged in a single row, each floating above a respective disk.

8. The device of claim 1, wherein the processor causes a synchronization message to appear on the top level UI informing a user that content synchronization with a server has been completed along with a number of new documents downloaded during the synchronization, a number of documents that were updated during the synchronization, a number of rich site summary (RSS) feeds that were updated during the synchronization.

9. The device of claim 1, wherein each second level UI includes an information pane indicating a top level category to which the second level UI pertains, the pane also including a link selector element to return to the top level UI and link selector elements to respectively link to other top level categories.

10. The device of claim 1, wherein the processor downloads UI changes from a server.

11. The device of claim 1, wherein the processor periodically queries a server for updated information.

12. An enterprise information management system for an enterprise, the system comprising:
an Internet computer server accumulating enterprise-related content including slide presentations, documents, images, and videos, the system allowing for event-tracking and custom content creation;
at least one client computing device accessing the content on the server, the server providing the client device with an enterprise information application (EIA) executable by a processor of the client computing device to present nested user interfaces (UI) on a display of the client device, the server providing the enterprise-related content uniformly to client devices associated with the enterprise during synchronization events between the server and client devices such that employees of the enterprise using the client devices are presented with coordinated, consistent enterprise information while on the go.

13. The system of claim 12, wherein the processor causes the display to present a top level user interface (UI) having at least three top level selector elements,
a first top level selector element being an executive insight selector element, a second top level selector element being a media selector element, and a third selector element being a public relations selector element,
the first top level selector element being selectable to cause a second level UI to be presented on the display presenting second level selector elements respectively selectable to present on the display at least information related to messaging guidelines, investor relations, analyst relations, and product briefs,
the second top level selector element being selectable to cause a second level UI to be presented on the display presenting second level selector elements respectively selectable to present on the display at least information related to video files available for presentation on the display and slide show presentations available for presentation on the display,
the third top level selector element being selectable to cause a second level UI to be presented on the display presenting second level selector elements respectively selectable to present on the display at least information related to press releases and social media.

14. The system of claim 13, wherein the top level UI presents one and only one name of an enterprise associated with the top level categories.

15. The system of claim 13, wherein the top level UI further comprises a fourth top level selector element selectable to cause a second level UI to be presented on the display presenting second level selector elements respectively selectable to present on the display at least information related to trade shows.

16. The system of claim 13, wherein the top level selector elements are presented as bars arranged in a single row or as bars arranged in a single column or as three dimensional parallelepipeds arranged in a single row, each parallelepiped floating above a respective disk.

17. The system of claim 13, wherein the processor causes a synchronization message to appear on the top level UI informing a user that content synchronization with a server has been completed along with a number of new documents downloaded during the synchronization, a number of documents that were updated during the synchronization, a number of rich site summary (RSS) feeds that were updated during the synchronization.

18. The system of claim 13, wherein each second level UI includes an information pane indicating a top level category to which the second level UI pertains, the pane also including a link selector element to return to the top level UI and link selector elements to respectively link to other top level categories.

19. Server comprising:
processor;
computer readable storage medium accessible by the processor to execute logic comprising:
determining whether an enterprise client device (ECD) has presented authorized credentials;
responsive to a determination that the ECD has presented authorized credentials, downloading the ECD an enterprise information application (EIA) executable by the ECD to present a nested set of user interfaces (UI) useful for accessing enterprise-related content;
periodically receiving from the client device executing the EIA a signal to synchronize the enterprise-related content and UI layout of the ECD; and
responsive to a determination that changes to the enterprise-related content have been made at the server since a most recent synchronization event with the ECD, downloading the changes to the ECD.

20. The server of claim 19, wherein the server receives new content from an enterprise control computer and stores the new content but does not download the new content to the ECD during a synchronization event unless the server first determines that the server has received a publish command related to the new content.

21. Computing device comprising:
processor;
display controlled by the processor; and
computer readable storage media accessible to the processor, the media storing documents downloaded from a server, the documents being associated with respective metadata indicating products and/or regions and/or audiences to which the documents pertain, the media bearing instructions executable by the processor to cause the display to present a user interface (UI) including a search selector element and selector elements enabling a user to input search terms related to products and/or regions and/or audiences, the processor returning an identification of documents from the media with metadata matching the search terms.

22. The device of claim 21, wherein the processor returns only documents from the media with metadata matching each and every search term input by the user and does not return documents on the media with metadata not matching each and every search term.

23. The device of claim 22, wherein the documents are associated with respective metadata indicating products and regions and audiences to which the documents pertain.

24. The device of claim 23, wherein the processor permits a user to select an entry from each product and region and audience selector element and returns only documents having metadata matching each user-selected entry from each product and region and audience selector element.
